(19) United States
(12) Patent Application Publication
(10) Pub. No.: US 2009/0037979 A1
(43) Pub. Date: Feb. 5, 2009

(54) Method and System for Recovering Authentication in a Network

(76) Inventors: George Dellaratta, JR., Shirley, NY (US); David Meyer, East Meadow, NY (US); Stalin Kumavarel, Bangalore (IN); Raghavendra Shivaraju, Bangalore (IN)

Correspondence Address: Fay Kaplun & Marcin, LLP/ Motorola, 150 Broadway Suite 702, New York, NY, 10038, US

(21) Appl. No.: 11/830,963

(22) Filed: Jul. 31, 2007

(51) Int. Cl. G06F 7/04

(52) U.S. Cl. 726/2

(57) ABSTRACT

Described is a system and method for recovering authentication of a mobile unit in a network. The method includes performing an attempt to authenticate a mobile unit based on a first profile; determining, if the attempt is unsuccessful, a number of attempts to authenticate based on the first profile including the attempt; performing, if the number of attempts is less than or equal to a predefined number, a further attempt to authenticate the mobile device based on the first profile; performing, if the number of attempts is greater than the predefined number, a profile roam to a second profile; and performing an additional attempt to authenticate the mobile unit based on the second profile.

### FIELD OF INVENTION

The present invention relates generally to a system and method for recovering authentication in a network. Specifically, exemplary embodiments of the present invention are related to systems and methods for reconnecting a mobile unit to a wireless network as the mobile unit returns to a network coverage range.

### BACKGROUND

Wireless networking has emerged as an inexpensive technology for connecting multiple users with other users within a wireless coverage area of a network as well as providing connections to other external networks, such as the World Wide Web. An exemplary wireless network may be a wireless local area network (“WLAN”) for providing radio communication between several devices using at least one wireless protocol, such as those of the 802.1x standards. A wireless local area network may use radio frequency (“RF”) communication channels to communicate between multiple mobile units (“MUs”) and multiple stationary access points. The access points or access ports (both may be referred to herein as “APs”) of the WLAN may be positioned in various location of the environment to prevent any coverage gaps of the wireless coverage.

In order to standardize the communications over a WLAN, the MUs may be equipped with wireless fidelity (“Wi-Fi”) capabilities, such as compatibility with one or more of the various 802.11x standards (i.e., 802.11a, 802.11b, 802.11g, etc.). The 802.11 standards are a set of Wi-Fi standards established by the Institute of Electrical and Electronics Engineers (“IEEE”) in order to govern systems for wireless networking transmissions.

An enterprise may deploy a wireless network in order to provide wireless coverage throughout the operating environment of the enterprise. A WLAN offers the enterprise several benefits ranging from cost efficiency to flexibility in installation and scaling. Furthermore, an operating environment having a limited wired infrastructure may easily be converted into WLAN, offering mobility to compatible wireless devices throughout the environment. However, while WLAN architectures may provide several units with network connectivity, issues such as network security and access control may compromise the privacy and safety of the data and/or users of a the network. Since users of MUs may frequently enter and exit WLAN coverage area and lose connectivity with the network, reconnecting these MUs with the WLAN may be a tedious task requiring informing several users of the network with secure login credentials.

### SUMMARY OF THE INVENTION

The present invention relates generally to a system and method for recovering authentication in a network. An exemplary embodiment of the method according to the present invention may include performing an attempt to authenticate a mobile unit based on a first profile; determining, if the attempt is unsuccessful, a number of attempts to authenticate based on the first profile including the attempt; performing, if the number of attempts is less than or equal to a predefined number, a further attempt to authenticate the mobile device based on the first profile; performing, if the number of attempts is greater than the predefined number, a profile roam to a second profile; and performing an additional attempt to authenticate the mobile unit based on the second profile.

An exemplary embodiment of the mobile unit according to the present invention may include a memory storing a first profile and a second profile; a communication link configured to communicate with at least one access point of a network; and a processor. The processor may be configured to send an authentication request based on the first profile to the access point via the communication link; determine, if the authentication request is denied, a number of prior authentication requests including the authentication request based on the first profile that have been made; send, if the number of prior authentication requests is less than or equal to a predefined number, a further authentication request to authenticate the mobile device based on the first profile; perform, if the number of prior authentication request is greater than the predefined number, a profile roam to a second profile; and send an additional authentication request to authenticate the mobile unit based on the second profile.

An exemplary embodiment of the system according to the present invention may include a storing means storing a first profile and a second profile; a communication means configured to communicate with at least one access point of a network; and a processing means. The processing means may be configured to send an authentication request based on the first profile to the access point via the communication link; determine, if the authentication request is denied, a number of prior authentication requests including the authentication request based on the first profile have been made; send, if the number of prior authentication requests is less than or equal to a predefined number, a further authentication request to authenticate the mobile device based on the first profile; perform, if the number of prior authentication request is greater than the predefined number, a profile roam to a second profile; and send an additional authentication request to authenticate the mobile unit based on the second profile.

### BRIEF DESCRIPTION OF THE DRAWINGS

FIG. 1 shows an exemplary system for authenticating one or more MUs within an operating environment according to the present invention.

FIG. 2 represents an exemplary method for establishing a connection to a network between the MU and the AP according to the present invention.

### DETAILED DESCRIPTION

The present invention may be further understood with reference to the following description of exemplary embodiments and the related appended drawings, wherein like elements are provided with the same reference numerals. The present invention is related to systems and methods used for authenticating a mobile unit (“MU”) within a communications network, such as a wireless local area network (“WLAN”). Specifically, MUs may be configured to use authentication prior to connecting with the communications network. However, during normal operation of an MU, the MU may move beyond the coverage area of the network and lose connectivity. Thus, the exemplary embodiments of the present invention are related to systems and methods for reconnecting the MU to the network as the MU returns to a network coverage range. Furthermore, the exemplary embodiments of the present invention may eliminate the need for a user of the MU to reenter, remember, or know the network access credentials. Accordingly, the present invention allows for improved security within the network by limiting the number of users that need to know the credentials required to access to the network.

Those skilled in the art would understand that the term “MU” according to the present invention may also be used to describe any mobile computing device, such as, for example, cellular telephones, voice over Internet protocol (“VoIP”) telephone receivers, personal digital assistants (“PDAs”), laptop computers, portable barcode scanners (e.g., laser and/or imager-based scanners), radio frequency identification (“RFID”) readers, global positioning system (“GPS”) devices, digital cameras, portable media players, medical equipment, etc.

In addition, it should be noted that while the exemplary systems and methods are implemented within a network, or networks, having a WLAN architecture, the present invention may be implemented within any other type of wireless network architecture, such as a wireless personal area network (“WPAN”) (e.g., Bluetooth), as a mesh network (e.g., an ad-hoc network), etc. Accordingly, the exemplary network may allow for radio frequency (“RF”) communication between several mobile and/or stationary network components using at least one wireless protocol, such as, for example, those of the 802.1x standards.

Furthermore, the exemplary embodiment takes advantage of the fact that network connection information may be known and stored within an MU as a part of the network access credentials. Specifically, a network administrator may configure the MU by entering these credentials, as well as network parameter information, into a memory of the MU, and may likewise configure other MUs throughout the network. The credentials may be included within a parameter set that describes a particular network, such as, identification data for distinguishing one network within an enterprise from any other networks.

The stored parameter set that includes the network credentials may be referred to as a device profile. The device profile allows the MU to be considered the user of the network, rather than an individual user. For example, in an environment where the individual users are not owners of the MU, e.g., a different individual uses the MU on different days, the network access credentials may be encrypted in the MU rather than each individual user having to remember their individual network access credentials. In contrast, the MU may also include a user profile that requires a user to enter their individual network access credentials.

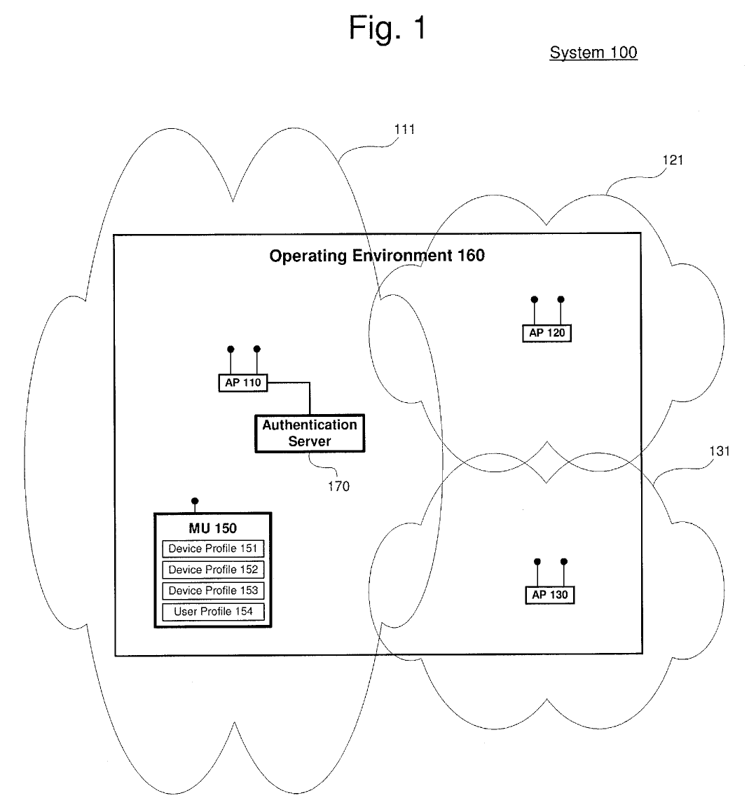

FIG. 1 shows an exemplary system 100 for authenticating an MU 150 within an operating environment 160 according to the present invention. The exemplary system 100 may utilize at least one network, such as a WLAN 111, that provides continuous wireless coverage through at least a portion of the operating environment 160. Furthermore, the operating environment 160 may include various network components (e.g., APs, authenticating servers, range-extending devices, signal repeaters/reflectors, etc.) configured in different locations and provide selective access for different users and/or MUs. Thus, the WLAN 111 may be described as a network infrastructure that allows for authorized wireless devices, such as MU 150, to be in communication with the AP 110 via radio waves.

Those skilled in the art will understand that the system 100 is only exemplary and that the present invention may be applied to any type of wireless network topology. As will be described in further detail below, the operating environment 160 may include additional networks accessible to the MU 150, such as networks 121 and 131. Each of the networks may provide differing levels of services to different locations through the operating environment 160. For example, one network (e.g., network 121) having a first AP (e.g., AP 120) may be located in a back office area and may be accessible to managerial personnel. While another network (e.g., 131) having a second AP (e.g., 130) may be located in a retail area and may be accessible to sales personnel. Furthermore, the exemplary WLAN 111 may provide overlapping coverage throughout the operating environment 160. It should be noted that any number of networks, in any variety coverage arrangements, may be utilized with the exemplary systems and methods according to the present invention.

According to an exemplary embodiment of the present invention, the MU 150 may include a plurality of profiles, device profiles 151-153 and user profile 154. While the exemplary MU 150 is illustrated as including four profiles, the MU 150 according to the exemplary embodiments of the present invention may include any number of profiles. As will be described in greater detail below, each of the device profiles 151-153 may include a parameter set for accessing a specific network. For example, the device profile 151 may describe a parameter set for accessing the WLAN 111, while the device profile 152 and the profile 153 describe parameter sets for accessing the network 121 and the network 131, respectively.

According to exemplary embodiments of the present invention, each of the networks 111, 121, 131 may be configured authenticate the MU 150 in order to verify that the MU 150 is a device authorized to access the networks 111, 121, and 131. The authentication process may include requesting network access credentials from the MU 150 when the MU 150 enters the coverage area, or range, of the network 111, 121, and 131.

For the remainder of the discussion of the exemplary authentication process, the discussion will be limited to the WLAN 111, but the process described may be equally applicable to other networks, including networks 121 and 131. During normal operation of the MU 150, the MU 150 may travel beyond the range of the AP 110, or otherwise fail to communicate with the AP 110, thereby losing connectivity to the WLAN 111. As will be described in further detail below, the exemplary system 100 may allow the MU 150 to efficiently and seamlessly (e.g., transparent to the user) reconnect to the WLAN 111, or connect with another network, once the MU 150 moves back into range of the AP 110, or within range of another AP.

Those of skill in the art would understand that a failure in communication between the MU 150 and the AP 110 may be caused by any number of reasons aside from the MU 150 traveling beyond the range of the AP 110. The causes may include, but are not limited to, the MU 150 being turned off, a loss of MU 150 battery power, the MU 150 being dysfunctional, etc. Accordingly, each of these causes may result in the MU 150 failing to communicate with the AP 110, or any AP of the operating environment 160. Throughout the description, the exemplary systems and methods of the present invention may consider any lack of communication between the MU 150 and the AP 110 as a communication failure (e.g., if the MU 150 has traveled beyond the network coverage area of a particular AP).

The exemplary operating environment 160 may be within a large establishment, such as, for example, a business office, a university, a department store, a mall, a warehouse, a storage lot, a home, etc. The operating environment 160 may maintain the WLAN 111 in order to provide continuous wireless coverage throughout multiple areas of the establishment. MUs may thus be deployed within this coverage to initiate communication with the AP 110 of the WLAN 111. Advantageously, the WLAN 111 may be set up within an establishment in an unobtrusive and inexpensive manner. Furthermore, the elimination of wires allows for the components of the WLAN 111 infrastructure to be placed in various locations and easily repositioned throughout the operating environment 160.

Within any network architecture, as described above, a network may be identified by a parameter set that describes the network. For example, using the IEEE 802.11 standard, the exemplary WLAN 111 may be identified by a parameter set including a service set identifier (“SSID”), wherein the SSID may serve as a label uniquely identifying the WLAN 111. Each of the network components within the WLAN 111 may use the same SSID in order to establish communications with the AP 110, or a group of APs.

The exemplary system 100 of the present invention may include an authenticating agent, such as an authentication server 170. Alternatively or additionally, the AP 110, itself, may act as the authenticating agent. The authenticating server 170 may authenticate the network access credentials (e.g., username and password) of the MU 150. For example, the authentication server 170 may store corresponding network access credentials for those MUs that are authorized to access WLAN 111. For each of the MUs that are successfully authenticated, the authentication server 170 may notify the AP of the successful authentication of the MU 150. Specifically, the MU 150 may include a unique device identification, such as, for example, an Internet Protocol (“IP”) address or a Medium Access Control (“MAC”) address. Thus, all future network traffic from the authenticated MU 150 may then pass through the AP 110 unimpeded and unaltered during normal operation of the system.

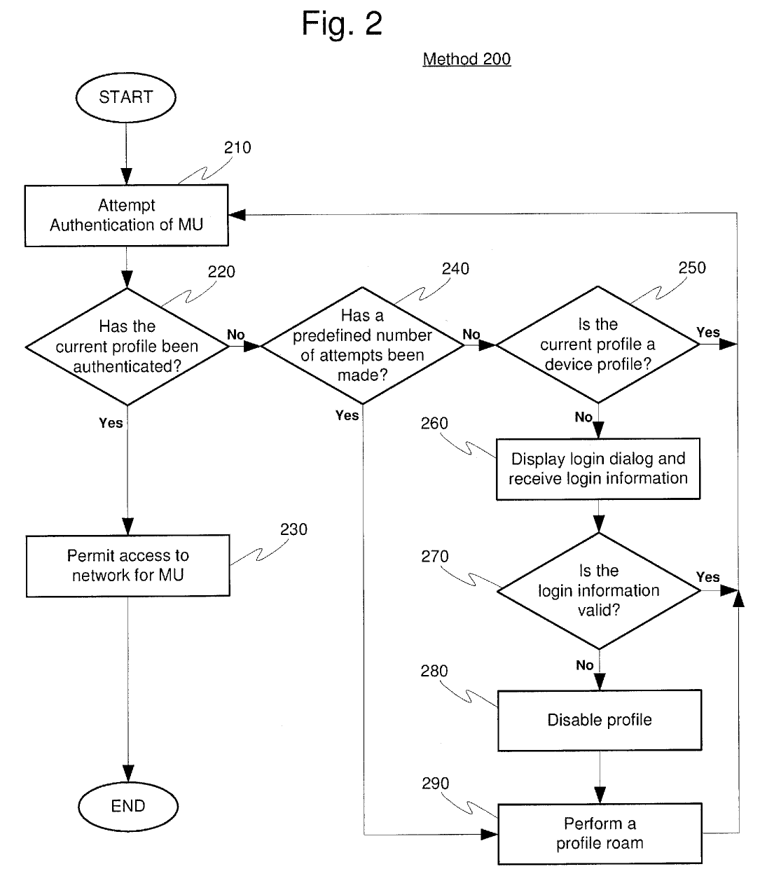

FIG. 2 represents an exemplary method 200 for connecting (or re-connecting) establishing a connection to a network, such as the WLAN 111, between the MU 150 and an AP, such as the AP 110, according to the present invention. The exemplary method 200 will be described with reference to the exemplary system 100 of FIG. 1. At the beginning of the method 200, it will be considered that the MU 150 is not currently connected to the WLAN 111 due to a connection failure and is now attempting to re-connect to one of the networks 111, 121, or 131 (e.g., the MU 150 is coming back into range, the MU 150 is powering up, etc.). Examples of the MU 150 may include desktop computers, laptop computers, voice over IP (“VoIP”) telephone receivers, personal digital assistants (“PDAs”), portable barcode scanners, and any mobile computing devices. According to the present invention, the method 200 may allow for the MU 150, or multiple MUs, to be authenticated in order to reconnect with the WLAN 111 via the AP 110, or alternatively, establish a connection with a different network within the operating environment 160.

In step 210, the MU 150 may attempt to authenticate using the device profile 151. As described above, during a preliminary configuration of the MU 150, a network administrator may provide the network access credentials for the MU 150 as a part of the parameter set that describes the WLAN 111. The parameter set may be stored on the MU 150 as a device profile for a particular network. As described above, the authentication process may involve validating the credentials of the MU 150. The credentials may include a username and password for network access, and may be in the form of key information, certificate information, etc. In addition, the credentials may be encrypted when placed onto the storage device of the MU 150. Thus, the encryption of the credentials may prevent unauthorized access to the network access credentials.

In the current example, it was assumed that the device profile 151 was the current device profile, i.e., the device profile initially used to attempt the authentication. The current device profile may be determined in a variety of manners. For example, in one embodiment, the current device profile may be the device profile for the network to which the MU 150 was most recently connected. In another example, the current device profile may be set to a default device profile, e.g., the network to which the MU 150 will most likely connect.

In step 220, the method 200 may determine if the MU 150 has been authenticated using the device profile 151. For example, if the authentication request based on the device profile 151 was transmitted to the AP 110, the MU 150 may have been authenticated because, as described above, the device profile 151 corresponds to the WLAN 111. On the other hand, if the authentication request based on the device profile 151 was transmitted to the AP 120, the MU 150 would not be authenticated because the device profile 151 does not correspond to the network 121. If the MU 150 has been authenticated, by either the authentication server 170 or the AP 110, the method 200 may advance to step 230 where the MU 150 may be permitted access to the WLAN 111 by the AP 110. However, if the MU 150 fails to be authenticated, the method 200 may advance to step 240.

In step 240, the method 200 may determine whether a predefined number of authentication attempts (from step 210) that have been performed by the MU 150 for a specific profile (e.g., the device profile 151). The predefined number of attempts may allow for multiple verifications of the MU 150, thereby decreasing the probability of an erroneous profile roam. For example, the predefined number of attempts may be set to three times. If the method 200 determines that three attempts have already been made to authenticate the device profile 151 of the MU 150, then the method may advance to step 290. In step 290, the MU 150 may perform a profile roam. A profile roam will be described in greater detail below. If the method 200 determines that less than three attempts have been made based on the device profile 151, then the method 200 may advance to step 250.

In step 250, the method 200 may make a determination as to what type of profile is being used by the MU 150 for authentication. Specifically, the method 200 may determine if the device profile 151 is a device profile. As discussed above, the device profile may be a parameter set defined and stored by a network administrator to describe a particular network, wherein the parameter set includes network setting, as well as network access credentials such as username and password for the MU 150. However, the profile may not be a device profile. Instead, the current profile may be of a different type, such as user profile 154, and thus may not have stored network access credentials required to access the networks 111, 121 and 131.

If the current profile is a device profile, the method 200 may return to step 210 and initiate a new attempt to authenticate the MU 150. However, if the current profile is determined to not be a device profile (e.g., user profile 154), then additional information may be required and the method 200 may advance to step 260 where the MU 150 may display a prompt (e.g., a login credential dialog box) and receive login information from the user. Specifically, the login credential dialog box may be displayed in order to provide a user with a chance to provide the user specific network access credentials, e.g., username, password. That is, those access credentials that are specific to the user rather than specific to the MU 150. Accordingly, this additional information may allow the MU 150 to be authenticated by the network to which the MU 150 is attempting to connect, e.g., by the authentication server 170 and/or the AP 110.

In step 270, the MU 150 may determine if the login information (e.g., network access credentials) received from the user are valid. According to the exemplary method 200 of the present invention, the network access credentials may be considered valid when the user has entered non-Null character strings within the credential dialog box described in step 260. If the credentials provided are valid, the method 200 may return to step 210 and initiate a new attempt to authenticate the MU 150. However, if the prompt (e.g., the credential dialog box) is canceled, then the method may advance to step 280.

In step 280, the method 200 may disable the current profile and advance to step 290 to perform a profile roam. Specifically, a profile roam may allow the MU 150 to switch from the current profile (e.g., device profile 151) to a different profile (e.g., the device profile 152 or the device profile 153) of the MU 150. As discussed above, the MU 150 may include a plurality of device profiles, wherein each device profile may define a parameter set for a different network within the operating environment 160. Accordingly, the profile roam step may substitute one of the other profiles 152, 153 of the MU 150 for the current device profile 151. After performing the profile roam to a new profile, the method 200 may return to initial step 210 in order to attempt authentication of the new profile.

For example, the MU 150 may have traveled beyond the range of the AP 110, or otherwise failed to communicate with AP 110, and thus the current device profile 151 describing the WLAN 111 may be ineffective in allowing the MU 150 to connect to the WLAN 111, or any network. However, the MU 150 may have traveled within the range of a different AP, such as AP 120 for the network 121. In order to access the network 121, a different profile may be required. Specifically, a different device profile that describes the parameter set for network 121 may be required for MU 150 to connect to the network 121. As described above, a network administrator may have stored the credentials as a part of the network parameter set for the network 121 (as well as credentials for several other networks) within the operating environment 160. Accordingly, the exemplary method 200 may allow the MU 150 to roam between available device profiles within the MU 150 (in step 290) when the method 200 is unable to authenticate the current device profile 151 of the MU 150. Specifically, the MU 150 may switch from the current device profile 151 to a new device profile (e.g., device profiles 152 or 153) and attempt to authenticate the new device profile. Thus, the exemplary method 200 may be used to reconnect the MU 150 with the current network (e.g., WLAN 111), or alternatively, establish a connection with a different network (e.g., network 121 or 131).

It will be apparent to those skilled in the art that various modifications may be made in the present invention, without departing from the spirit or the scope of the invention. Thus, it is intended that the present invention cover modifications and variations of this invention provided they come within the scope of the appended claimed and their equivalents.

What is claimed is:

1. A method, comprising:
performing an attempt to authenticate a mobile unit based on a first profile;
determining, if the attempt is unsuccessful, a number of attempts to authenticate based on the first profile including the attempt;
performing, if the number of attempts is less than or equal to a predefined number, a further attempt to authenticate the mobile device based on the first profile;
performing, if the number of attempts is greater than the predefined number, a profile roam to a second profile; and
performing an additional attempt to authenticate the mobile unit based on the second profile.

2. The method of claim 1, further comprising:
determining, if the number of attempts is less than or equal to the predefined number and prior to performing the further attempt, whether the first profile is a device profile.

3. The method of claim 2, further comprising:
displaying a prompt to enter login credentials if the first profile is not a device profile;
determining if the login credentials are valid, wherein the login credentials are valid when non-null character strings are received via the prompt;
performing, if the login credentials are valid, another attempt to authenticate the mobile device based on the login credentials;
disabling, if the login credential are invalid, the first profile; and
performing the profile roam to the second profile.

4. The method according to claim 1, further including:
providing, if the mobile unit is authenticated, the mobile unit with access to a network having at least one access point.

5. The method according to claim 4, wherein the communication between the mobile unit and the at least one access point is a wireless communication.

6. The method according to claim 4, wherein the authentication of the mobile unit is performed by one of the access point and an authentication server.

7. The method according to claim 4, wherein the network is one of a wireless local area network (“WLAN”), a wireless personal area network (“WPAN”), and a mesh network.

8. The method according to claim 3, wherein the credentials include a username and a password for accessing the network.

9. The method according to claim 1, wherein the first profile includes network access credentials.

10. The method according to claim 1, wherein the mobile unit is one of a personal digital assistant (“PDA”), a cell phone, a Voice over Internet Protocol (“VoIP”) phone, a laptop, a handheld computer, a portable barcode scanner, and a non-mobile computing device attached to a network interface card.

11. A mobile unit comprising:
a memory storing a first profile and a second profile;
a communication link configured to communicate with at least one access point of a network; and
a processor configured to:
send an authentication request based on the first profile to the access point via the communication link;
determine, if the authentication request is denied, a number of prior authentication requests including the authentication request based on the first profile that have been made;
send, if the number of prior authentication requests is less than or equal to a predefined number, a further authentication request to authenticate the mobile device based on the first profile;
perform, if the number of prior authentication request is greater than the predefined number, a profile roam to a second profile; and
send an additional authentication request to authenticate the mobile unit based on the second profile.

12. The mobile unit of claim 11, wherein the processor is further configured to determine, if the number of attempts is less than or equal to the predefined number and prior to performing the further attempt, whether the first profile is a device profile.

13. The mobile unit of claim 12, wherein the processor is further configured to:
displaying a prompt to enter login credentials if the first profile is not a device profile;
determine if the login credentials are valid, wherein the login credentials are valid when non-null character strings are received via the prompt;
perform, if the login credentials are valid, another attempt to authenticate the mobile device based on the login credentials;
disable, if the prompt is canceled, the first profile; and
perform the profile roam to the second profile.

14. The mobile unit of claim 11, wherein the processor is further configured to provide, if the mobile unit is authenticated, the mobile unit with access to a network having at least one access point.

15. The mobile unit of claim 11, wherein the communication between the mobile unit and the at least one access point is a wireless communication.

16. The mobile unit of claim 11, wherein the attempt to authenticate the mobile unit are performed by one of the access point of the network and an authentication server.

17. The mobile unit of claim 11, wherein the network is one of a wireless local area network (“WLAN”), a wireless personal area network (“WPAN”), and a mesh network.

18. The mobile unit of claim 13, wherein the credentials include a username and a password for accessing the network.

19. The mobile unit of claim 13, wherein the credentials are encrypted and include one of a key information and a certificate information for decrypting the credentials.

20. The mobile unit of claim 11, wherein the mobile unit is one of a personal digital assistant (“PDA”), a cell phone, a Voice over Internet Protocol (“VoIP”) phone, a laptop, a handheld computer, a portable barcode scanner, and a non-mobile computing device attached to a network interface card.

21. A system, comprising:
a storing means for storing a first profile and a second profile;
a communication means configured to communicate with at least one access point of a network; and
a processing means configured to:
send an authentication request based on the first profile to the access point via the communication link;
determine, if the authentication request is denied, a number of prior authentication requests including the authentication request based on the first profile have been made;
send, if the number of prior authentication requests is less than or equal to a predefined number, a further authentication request to authenticate the mobile device based on the first profile;
perform, if the number of prior authentication request is greater than the predefined number, a profile roam to a second profile; and
send an additional authentication request to authenticate the mobile unit based on the second profile.

22. The system of claim 21, wherein if the number of attempts is less than or equal to the predefined number and prior to performing the further attempt, processing means determines whether the first profile is a device profile.

23. The system of claim 22, further comprising:
a display means for displaying a prompt to enter login credentials if the first profile is not a device profile; and
a validating means for determining if the login credentials are valid, the login credentials are valid when non-null character strings are received via the prompt, wherein processing means performs another attempt to authenticate the mobile device based on the login credentials if the login credentials are valid; and
a profile disabling means for disabling, if the login credential are invalid, the first profile, wherein the profile roaming means performs the profile roam to the second profile.

24. The system to claim 21, wherein the processing means provides, if the mobile unit is authenticated, the mobile unit with access to a network having at least one access point.
